(19) United States
(12) Patent Application Publication
(10) Pub. No.: US 2025/0288842 A1
(43) Pub. Date: Sep. 18, 2025

(54) METHODS AND COMPOSITIONS FOR REDUCING RESIDUAL HERBICIDES

(71) Applicant: Valent U.S.A. LLC, San Ramon, CA (US)

(72) Inventors: Tim Arndt, El Sobrante, CA (US); Ken Nelson, Martinez, CA (US); John Andrew Pawlak II, Lansing, MI (US); Joel Maurer, Dublin, CA (US); Pat Clay, Fresno, CA (US); Kirk Gohre, Vallejo, CA (US); Randall Landry, Monticello, IL (US); Jon Kohrt, Noblesville, IN (US); Lipi Parikh, Rogers, AR (US); Matt Griffin, Cleveland, MS (US); Brian Lin, Fremont, CA (US)

(21) Appl. No.: 19/081,260

(22) Filed: Mar. 17, 2025

Related U.S. Application Data
(60) Provisional application No. 63/566,687, filed on Mar. 18, 2024.

(51) Int. Cl. A62D 3/30; A62D 101/04

(52) U.S. Cl. CPC A62D 3/30; A62D 2101/04

(57) ABSTRACT

The present invention is directed to methods of eluting protoporphyrinogen oxidase inhibitors from agricultural equipment comprising contacting the agricultural equipment with a composition comprising one or more amines. The present invention is further directed to compositions for eluting protoporphyrinogen oxidase inhibitors from agricultural equipment comprising one or more amines. The present invention is further directed to methods of degrading protoporphyrinogen oxidase (“PPO”) inhibitors comprising contacting the PPO inhibitors with an effective amount of a composition comprising one or more amines. The present invention is further directed to compositions for degrading protoporphyrinogen oxidase inhibitors comprising an effective amount of one or more amines.

### FIELD OF THE INVENTION

The present invention is directed to methods of eluting protoporphyrinogen oxidase (“PPO”) inhibitors from agricultural equipment comprising contacting the agricultural equipment with a composition comprising one or more amines. The present invention is further directed to compositions for eluting PPO inhibitors from agricultural equipment comprising one or more amines. The present invention is further directed to methods of degrading PPO inhibitors comprising contacting the PPO inhibitors with an effective amount of a composition comprising one or more amines. The present invention is further directed to compositions for degrading PPO inhibitors comprising an effective amount of one or more amines.

### BACKGROUND OF THE INVENTION

Protoporphyrinogen oxidase (“PPO”) inhibitors are herbicides that primarily control broadleaf weeds. PPO inhibitors create highly toxic molecules upon contact with the weed that result in destruction of plant tissue. As such, PPO inhibitors are effective herbicides at concentrations as low as 10 grams per hectare (e.g. 72 ppm sprayed at 15 gallons per acre). See Hao et al., Protoporphyrinogen oxidase inhibitor: an ideal target for herbicide discovery, 2011, Chimia, 65 (12) 961-9.

Due to the effectiveness of PPO inhibitors at very low concentrations, growers must thoroughly clean the application equipment after application of PPO inhibitors or else risk harming crops sensitive to PPO inhibitors such as cotton, legumes, Canola, etc . . . . For example, butafenacil, an extremely effective PPO inhibitor and can easily contaminate application equipment by leaving behind a tenacious residue that is challenging to remove. One way to overcome contamination issues when the same application equipment was used for further application of other agricultural products to sensitive crops was the use of dedicated equipment for butafenacil.

Current cleaning practices including physical scrubbing are insufficient to remove residual PPO inhibitor residue from agricultural equipment. In fact, there does not currently exist a method capable of reducing the levels of highly efficacious PPO inhibitors in the application equipment such that residual PPO inhibitors within the equipment does not damage crops when applying subsequent applications to the crops.

Thus, there exists a need in the art for methods of reducing the levels of PPO inhibitors in agricultural equipment to reduce and/or prevent crop damage upon further use of the equipment.

### SUMMARY OF THE INVENTION

In one aspect, the present invention is directed to methods of eluting protoporphyrinogen oxidase (“PPO”) inhibitors from agricultural equipment comprising contacting the agricultural equipment with an effective amount of a composition comprising one or more amines.

In another aspect, the present invention is directed to methods of degrading PPO inhibitors comprising contacting the PPO inhibitors with an effective amount of a composition comprising one or more amines.

In another aspect, the present invention is directed to compositions for eluting protoporphyrinogen oxidase inhibitors from agricultural equipment comprising an effective amount of one or more amines.

In another aspect, the present invention is directed to compositions for degrading PPO inhibitors comprising an effective amount of one or more amines.

### DETAILED DESCRIPTION OF THE INVENTION

The Applicant has surprisingly discovered that amines are capable of eluting protoporphyrinogen oxidase (“PPO”) inhibitors from agricultural equipment to levels that prevent damage to crops upon subsequent use of the equipment. The amines can achieve effective cleanout of the equipment with minimal effort from the grower. This result is surprising as no methods currently exist that can remove sufficient PPO inhibitor from agricultural equipment with such minimal effort.

The Applicant has further surprisingly discovered that amines are capable of degrading PPO inhibitors. The amines are capable of degrading the PPO inhibitors while the PPO inhibitors are in contact with agricultural equipment. The amines effectively degrade the PPO inhibitors such that the PPO inhibitors no longer have an herbicidal effect. This result is surprising as no methods currently exist that can eliminate sufficient intact PPO inhibitors from agricultural equipment with such minimal effort.

In one embodiment, the present invention is directed to methods of eluting PPO inhibitors from agricultural equipment comprising contacting the agricultural equipment with an effective amount of a composition comprising one or more amines.

In a preferred embodiment, the compositions of the present invention comprising one or more amines are in contact with the agricultural equipment for at least about 1 hour, more preferably at least about 2 hours, even more preferably at least about 3 hours, yet even more preferably at least about 4 hours and most preferably at least about 5 hours. In another preferred embodiment, the compositions of the present invention are in contact with the agricultural equipment for about 1 to about 24 hours, more preferably for about 2 to about 18 hours and even more preferably for about 3 to about 10 hours.

In another embodiment, the present invention is directed to methods of degrading PPO inhibitors comprising contacting the PPO inhibitors with an effective amount of a composition comprising one or more amines.

In a preferred embodiment, the PPO inhibitors are in contact with agricultural equipment prior to and during contact with the composition comprising one or more amines.

In another preferred embodiment, the compositions of the present invention comprising one or more amines are in contact with the PPO inhibitor for at least about 1 hour, more preferably at least about 2 hours, even more preferably at least about 3 hours, yet even more preferably at least about 4 hours and most preferably at least about 5 hours. In another preferred embodiment, the compositions of the present invention are in contact with the PPO inhibitor for about 1 to about 24 hours, more preferably for about 2 to about 18 hours and even more preferably for about 3 to about 10 hours.

In a preferred embodiment, the agricultural equipment of the present invention comprises a hose or a line.

In another preferred embodiment, the agricultural equipment of the present invention comprises one or more materials selected from the group consisting of natural rubber, synthetic rubber, synthetic plastic polymers, polyurethane blends and polyethylene blends. In a more preferred embodiment, the agricultural equipment of the present invention is natural rubber or synthetic rubber.

In another embodiment, the present invention is directed to compositions for eluting protoporphyrinogen oxidase inhibitors from agricultural equipment comprising an effective amount of one or more amines.

As used herein the term “protoporphyrinogen oxidase inhibitor” or “PPO inhibitor” refers, but is not limited to, any compound capable of inhibiting the oxidation of protoporphyrinogen through interaction with the protoporphyrinogen oxidase enzyme, including those compounds not yet discovered or synthesized. Current PPO inhibitors include, but are not limited to: diphenyl ethers such as acifluorfen-sodium, bifenox, chlornitrofen, chlomethoxyfen, ethyoxyfen-ethylfluoroglycofen-ethyl, fomesafen, lactofen and oxyfluorfen; N-phenyl-imides such as cinidon-ethyl, flumiclorac-pentyl, epyrifenacil, trifludimoxazin, tiafenacil, butafenacil, saflufenacil, pentoxazone, fluthiacet-methyl, trifludimoxazin and flumioxazin; N-phenyltriazolinones such as sulfentrazone and carfentrazone-ethyl; N-phenyl-oxadiazolones such as oxadiazon and oxadiargyl; phenylpyrazoles such as fluazolate and pyraflufen-ethyl; N-phenyl-triazolinones such as azafenidin, carfentrazone-ethyl and sulfentrazone; and others such as flufenpyr-ethyl, profluazol, pyraclonil, benzfendizone and thidiazimin.

As used herein the term “amine” refers to a compound comprising a nitrogen atom with a lone pair of electrons, wherein the nitrogen atom is chemically bound to at least three atoms wherein at least one of those three atoms is not hydrogen. Amines suitable for use in the present invention include, but are not limited to, alkylamines, arylamines and alkylarylamines. As used herein the term “alkylamine” refers to an amine wherein the nitrogen atom is bound to at least one alkyl substituent. As used herein the term “arylamine” refers to an amine wherein the nitrogen atom is bound to at least one aryl substituent. As used herein the term “alkylarylamine” refers to an amine wherein the nitrogen atom is bound to at least one alkyl substituent and at least one aryl substituent.

As used herein the term “alkyl” refers to a straight or branched chain alkane radical (i.e. a group missing one of the hydrogen atoms required for a stable structure), (—CₙH₂ₙ₊₁). Examples of alkyls include methyl, ethyl, propyl, iso-propyl, butyl, sec-butyl, pentyl, hexyl, heptyl, octyl, nonyl, decyl, undecyl, dodecyl and isomers thereof.

As used herein the term “aryl” refers to a substituted or unsubstituted aromatic carbocyclic group of from 6 to 20 carbon atoms having a single ring (for example, phenyl) or multiple condensed (fused) rings, wherein at least one ring is aromatic (for example, naphthyl, dihydrophenanthrenyl, fluorenyl, or anthryl).

As used herein the term “effective amount” may refer to the amount of the composition or amines that will elute the PPO inhibitors from the agricultural equipment wherein the amount of PPO inhibitors remaining on the agricultural equipment is less than the amount that would cause harm to crops by using the agricultural equipment to apply a subsequent composition to the crops. An appropriate “effective amount” may vary between the type of agricultural equipment, the material contained in the agricultural equipment that comes in contact with the PPO inhibitor and the type of amine contained in the composition of the present invention.

As used herein the term “effective amount” may also refer to the amount of the composition or amines that will degrade the PPO inhibitors wherein the amount of intact PPO inhibitors remaining is less than the amount that would cause harm to crops by applying the remaining intact PPO inhibitors to crops. An appropriate “effective amount” may vary between the type of PPO inhibitor and the type of amine contained in the composition of the present invention.

As used herein the term “degrade” or “degradation” refers to changes in the chemical structure of the PPO inhibitor such that the PPO inhibitor is less effective as an herbicide as compared to the PPO inhibitor that has not changed in chemical structure.

As used herein the term “agricultural equipment” refers to any equipment used in the application of PPO inhibitors to crops or areas in which crops will grow.

The disclosed embodiments are simply exemplary embodiments of the inventive concepts disclosed herein and should not be considered as limiting, unless the claims expressly state otherwise.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a”, “an” and “the” are intended to include the plural as well as the singular, unless the context clearly indicates otherwise.

### EXAMPLES

### Example 1. PPO Inhibitor Degradation

### Method

PPO inhibitors were dissolved in methanol or acetonitrile (1.00 milliliters) to prepare a stock solution. To determine the ability of amine cleaners to degrade these PPO inhibitors, 10 milliliters of an amine composition with or without potassium hydroxide was added to test vials. Then, 200 microliters of each PPO inhibitor stock solution was added to separate test vials and mixed thoroughly. To measure the concentration of the PPO inhibitor at the different time points, the degradation process was stopped by reducing the pH with 10 drops of concentrated HCl (pH<2). Acetonitrile (10 milliliters) was then added and the test vials were shaken for 1 minute. Next, 4.5 grams of sodium sulfate and 2 grams of sodium chloride were added and the test vials were shaken for an additional 1 minute. The test vials were centrifuged and the top layer was analyzed for the concentration of the PPO inhibitor. The mixture was processed for analysis and the concentration of the PPO inhibitor was measured using standard high performance liquid chromatography as 0, 5, 30 and 120 minutes.

Results of this experiment can be found in Table 1, below.

TABLE 1

| | | Epyrifenacil | | Flumioxazin | |
|---|---|---|---|---|---|
| | Exposure | ppm | percent | ppm | percent |
| Treatment | time (min) | remaining | remaining | remaining | remaining |
| Amine | 0 | 247 | 100% | 295 | 100% |
| Composition | 5 | 15.0 | 6% | 6.24 | 2% |
| with KOH | 30 | 0 | 0% | 4.54 | 2% |
| | 120 | — | — | 3.33 | 1% |
| | 18.5 hrs | — | — | 2.78 | 0.9% |
| Amine | 0 | 253 | 100% | 300 | 100% |
| Composition | 5 | 12.2 | 5% | 39.1 | 13% |
| without KOH | 30 | 0 | 0% | 21.1 | 7% |
| | 120 | — | — | 9.32 | 3% |
| | 18.5 hrs | — | — | 0.47 | 0.2% |
| | | Butafenacil | | Lactofen | |
| | Exposure | ppm | percent | ppm | percent |
| Treatment | time (min) | remaining | remaining | remaining | remaining |
| Amine | 0 | 239 | 100% | 285 | 100% |
| Composition | 5 | 15.1 | 6% | 25.4 | 9% |
| with KOH | 30 | 3.36 | 1% | 0 | 0% |
| | 120 | 1.86 | 1% | 0 | 0% |
| Amine | 0 | 245 | 100% | 308 | 100% |
| Composition | 5 | 98.6 | 40% | 115 | 37% |
| without KOH | 30 | 17.6 | 7% | 0 | 0% |
| | 120 | 3.72 | 2% | 0 | 0% |

### Results

As seen in Table 1, above, the composition containing amines degraded the intact PPO inhibitors. These amine compositions were capable of degrading PPO inhibitors even without the addition of an alkaline base (i.e. potassium hydroxide), a common herbicide commercial cleaner component. Thus, amine compositions are capable of degrading PPO inhibitors.

### Example 2. In-Situ PPO Inhibitor Degradation

### Method

Synthetic rubber hoses were each filled with a composition containing 528 ppm of epyrifenacil, a fraction of which is radiolabeled with a C-14 isotope as a tracer and each hose was capped on both ends. The capped hoses were stored for approximately 18 hours at room temperature. Following storage, the hoses were emptied, rinsed with water and then filled with a cleaning solution as identified in Table 1, below, and re-capped. The hoses were then stored a second time for approximately 18 hours at room temperature. Following the second storage each hose was emptied, rinsed with water and then filled with a glyphosate composition and re-capped to simulate a subsequent use of agricultural equipment. The hoses were then stored a third time for 30 minutes at room temperature. Following the third storage, each hose was emptied into individual vessels and measured for intact epyrifenacil content using standard radiolabeling detection. Results of this experiment can be found in Table 2, below.

TABLE 2

| | Percent of Intact PPO |
|---|---|
| Composition | inhibitor eluted with glyphosate |
| Composition Blank | 99% |
| Potassium Hydroxide Composition | 99% |
| Tetraethylammonium Hydroxide | 99% |
| Composition | |
| Amine Composition | 73% |

### Results

As seen in Table 2, above, the composition containing amines degraded the intact epyrifenacil such that only 73% of the epyrifenacil that was eluted with the glyphosate composition was intact. This is in stark contrast to potassium hydroxide and tetraethylammonium hydroxide each of which resulted in 99% of the epyrifenacil eluted by the glyphosate composition being intact, which is the same as the blank control formulation. Thus, amine compositions are capable of degrading PPO inhibitors in-situ in agricultural equipment.

### Example 3. Further In-Situ PPO Inhibitor Degradation

### Method

Synthetic rubber hoses were each filled with a composition containing 930 ppm flumioxazin or 215 ppm epyrifenacil and each hose was capped on both ends. The capped hoses were stored for approximately 18 hours at room temperature. Following storage, the hoses were emptied, rinsed with water and then filled with a cleaning solution as identified in Table 3, below, and re-capped. The hoses were then stored a second time for approximately 5 hours at room temperature. Following the second storage each hose was emptied, rinsed with water and then filled with a glyphosate composition and re-capped to simulate a subsequent use of agricultural equipment. The hoses were then stored a third time for 30 minutes at room temperature. Following the third storage, each hose was emptied into individual vessels and measured for intact flumioxazin or epyrifenacil content using standard cold high-pass liquid chromatography. Results of this experiment can be found in Table 3, below.

TABLE 3

| | Flumioxazin | | Epyrifenacil | |
|---|---|---|---|---|
| | | Elution | | Elution |
| | | in | | in |
| | Starting | Glyphosate | Starting | Glyphosate |
| Treatment | Composition | (ppm) | Composition | (ppm) |
| Composition | 930 | 1.206 | 215 | 2.240 |
| Blank | | | | |
| Amine | 930 | 0.074 | 215 | 0.051 |
| Composition | | | | |

### Results

As seen in Table 3, above, the composition containing amines resulted in much smaller concentrations of flumioxazin and epyrifenacil being eluted with the glyphosate composition. Thus, amine compositions are capable of eluting PPO inhibitors in-situ in agricultural equipment.

### Example 4. Phytotoxicity Screening

### Method

To test the concentration necessary to achieve phytotoxicity in cotton grown under laboratory conditions, flumioxazin and epyrifenacil were applied to cotton along with glyphosate at the concentrations in Table 4, below. As a control both untreated cotton and glyphosate treated cotton are shown. Results can be found in Table 4, below. Statistical significance is shown by letters wherein values sharing a letter are not statistically different.

TABLE 4

| | Dilution | % | |
|---|---|---|---|
| Treatment | (ppb) | Injury | |
| Untreated | — | 0 | |
| Glyphosate | — | 2 | e |
| Flumioxazin | 5350 | 62 | a |
| Flumioxazin | 1340 | 31 | b |
| Flumioxazin | 334 | 6.7 | cd |
| Flumioxazin | 83 | 3 | cde |
| Flumioxazin | 21 | 2 | e |
| Epyrifenacil | 5350 | 61 | a |
| Epyrifenacil | 1340 | 32 | b |
| Epyrifenacil | 334 | 7 | c |
| Epyrifenacil | 83 | 2.6 | de |
| Epyrifenacil | 21 | 2 | e |

### Results

As demonstrated in Table 4, above, flumioxazin and epyrifenacil were found to cause significant cotton injury at 334 ppb and did not cause significant cotton injury at 83 ppb. Thus, the amine cleaners of the present invention which reduced flumioxazin and epyrifenacil to 74 and 51 ppb, as demonstrated in Table 3 above, are capable of reducing concentrations of these PPO inhibitors to below phytotoxic levels.

### Example 5. Field Efficacy

### Method

To test the efficacy of the amine compositions, 2.5 gallons of a PPO inhibitor product, at about 143 ppm, with 1% v/v crop oil concentrate was prepared at recommended use rate and filled into test booms. The solution was held in the test booms under 30-50 PSI for 8 hours. At the end of 8 hours the reaming solution was pushed through the lines. Hoses were allowed to dry for a minimum of 12 hours. After the drying period, 2.5 gallons of water was sprayed through each line. The boom was then primed with cleaning solutions as detailed in Table 4, below, until spray pattern was adequate at which time the spraying was stopped. The pressurized cleaner filled boom was held under pressure for 5 hours. At the end of 5 hours, the cleaning solution was sprayed through the lines followed by 2.5 gallons of water.

Roundup Power Max® 3 was used as the subsequent use product. Roundup Power Max® 3 @ 30 fl oz/A+NIS @ 0.25% v/v was primed in test boom and maintained under pressure for 1 hour. After 1 hour the sprayer was started and the first 1.3 liters of solution was collected. The solutions were spray on cotton and soybean with 1 to 2 leaves at a rate of 15 gallons per acre. The level of phytotoxicity was evaluated at 5 days after application. Results of this experiment can be found in Table 5, below.

TABLE 5

| | Cotton | Soybean |
|---|---|---|
| Composition | Phytotoxicity | Phytotoxicity |
| Roundup Power Max ® 3 | 12 | 7 |
| Commercial Cleaner: Sodium | 19 | 12 |
| Hydroxide/Surfactant Cleaner | | |
| Amine composition | 7.5 | 2.5 |

As demonstrated in Table 5, above, equipment cleaned with an amine composition resulted in lower phytotoxicity as compared to equipment cleaned using a commercial cleaner. Thus, amine compositions are capable of degrading and eluting PPO inhibitors from agricultural equipment such that subsequent applications using the equipment does not result in an increase phytotoxicity to desired crops.

What is claimed is:

1. A method of eluting protoporphyrinogen oxidase inhibitors from agricultural equipment comprising contacting the agricultural equipment with an effective amount of a composition comprising one or more amines.

2. The method of claim 1, wherein the composition contacts the agricultural equipment for at least about 1 hour.

3. The method of claim 2, wherein the composition contacts the agricultural equipment for at least about 3 hours.

4. The method of claim 3, wherein the composition contacts the agricultural equipment for at least about 5 hours.

5. The method of claim 1, wherein the agricultural equipment comprises a hose or a line.

6. The method of claim 1, wherein the agricultural equipment comprises one or more materials selected from the group consisting of natural rubber, synthetic rubber, synthetic plastic polymers, polyurethane blends and polyethylene blends.

7. A composition for eluting protoporphyrinogen oxidase inhibitors from agricultural equipment comprising an effective amount of one or more amines.

8. A method of degrading protoporphyrinogen oxidase (PPO) inhibitors comprising contacting the PPO inhibitors with an effective amount of a composition comprising one or more amines.

9. The method of claim 8, wherein the composition comprising one or more amines are in contact with the PPO inhibitors for at least about 1 hour.

10. The method of claim 9, wherein the composition comprising one or more amines are in contact with the PPO inhibitors for at least about 3 hours.

11. The method of claim 10, wherein the composition comprising one or more amines are in contact with the PPO inhibitors for at least about 5 hours.

12. The method of claim 8, wherein the PPO inhibitors are in contact with agricultural equipment prior to and during contact with the composition comprising one or more amines.

13. The method of claim 12, wherein the agricultural equipment comprises a hose or a line.

14. The method of claim 12, wherein the agricultural equipment comprises one or more materials selected from the group consisting of natural rubber, synthetic rubber, synthetic plastic polymers, polyurethane blends and polyethylene blends.

15. A composition for degrading protoporphyrinogen oxidase inhibitors comprising an effective amount of one or more amines.
